(19) United States
(12) Patent Application Publication
(10) Pub. No.: US 2026/0319927 A1
(43) Pub. Date: Oct. 15, 2026

(54) SYSTEMS AND METHODS FOR TRAINING A MODEL ON AUTOMATION TESTS AND USING THE SAME

(71) Applicant: Comcast Cable Communications, LLC, Philadelphia, PA (US)

(72) Inventor: Benjamin Sautner, Philadelphia, PA (US)

(21) Appl. No.: 19/174,506

(22) Filed: Apr. 9, 2025

(51) Int. Cl. G06F 11/3668; G06N 20/00

(52) U.S. Cl. CPC G06F 11/3688; G06N 20/00

(57) ABSTRACT

Methods may include determining a plurality of software test scripts. Methods may include causing at least a portion of the plurality of software test scripts to be executed on one or more software applications and cause actual outcomes. Methods may include determining whether each actual outcome is a positive outcome or a negative outcome based on if each actual outcome matches an associated expected outcome. Methods may include determining a first dataset having the software test scripts that resulted in a positive outcome and excluding the software test scripts that resulted in a negative outcome. Methods may include training, based on the first dataset, a model. Other embodiments of this aspect include corresponding computer systems, apparatus, and computer programs recorded on one or more computer storage devices, each configured to perform the actions of the methods.

### BACKGROUND

When software is modified, software test scripts may be created to test the modifications before the modifications are incorporated into a live environment. A user using the modification may need assistance. A developer looking at source code associated with the modifications may need guidance.

Improvements are needed.

### SUMMARY

It is to be understood that both the following general description and the following detailed description are exemplary and explanatory only and are not restrictive. Methods and systems for using software tests to train a model are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Methods may include determining a model configured to respond to user queries related to a software application. Methods may include determining a plurality of software test scripts. Methods may include causing at least a portion of the plurality of software test scripts to be executed on the software application. Execution of the at least a portion of the plurality of software test scripts on the software application may include each of the at least a portion of the plurality of software test scripts to execute within a test environment associated with the software application and cause an actual outcome. Methods may include determining whether each actual outcome is a positive outcome based on if each actual outcome matches an associated expected outcome. Methods may include determining a first dataset having the software test scripts that resulted in a positive outcome and excluding the software test scripts that resulted in a negative outcome. Methods may include training the model based on the first dataset. Other embodiments of this aspect include corresponding computer systems, apparatus, and computer programs recorded on one or more computer storage devices, each configured to perform the actions of the methods.

Methods may include determining a plurality of software test scripts. Methods may include causing at least a portion of the plurality of software test scripts to be executed on one or more software applications and causing an actual outcome. Method may include determining whether each actual outcome is a positive outcome or a negative outcome based on if each actual outcome matches an associated expected outcome. Methods may include determining a first dataset having the software test scripts that resulted in a positive outcome and excluding the software test scripts that resulted in a negative outcome. Methods may include training, based on the first dataset, a model. Other embodiments of this aspect include corresponding computer systems, apparatus, and computer programs recorded on one or more computer storage devices, each configured to perform the actions of the methods.

Methods may include determining a model configured to respond to user queries related to a software application. Methods may include determining a plurality of software test scripts. Methods may include causing at least a portion of the plurality of software test scripts to be executed on the software application and cause an actual outcome. Methods may include determining whether each actual outcome is a positive outcome or a negative outcome based on if each actual outcome matches an associated expected outcome. Methods may include determining a first dataset having the software test scripts that resulted in a positive outcome and excluding the software test scripts that resulted in a negative outcome. Methods may include for each entry in the first dataset, capturing image content. At least one image in the captured image content may comprise a screenshot. Methods may include training, based on the first dataset, the model. Other embodiments of this aspect include corresponding computer systems, apparatus, and computer programs recorded on one or more computer storage devices, each configured to perform the actions of the methods.

Devices may include one or more processors configured to: determine a model configured to respond to user queries related to a software application; determine a plurality of software test scripts; cause at least a portion of the plurality of software test scripts to be executed on the software application, where execution of the at least a portion of the plurality of software test scripts on the software application may include causing each of the at least a portion of the plurality of software test scripts to execute within a test environment associated with the software application and cause an actual outcome; determine whether each actual outcome is a positive outcome based on if the actual outcome matches an associated expected outcome; determine a first dataset having the software test scripts that resulted in a positive outcome and excluding the software test scripts that resulted in a negative outcome; and train the model based on the first dataset.

Devices may include one or more processors configured to: determine a plurality of software test scripts; cause at least a portion of the plurality of software test scripts to be executed on one or more software applications and cause an actual outcome; determine whether each actual outcome is a positive outcome or a negative outcome based on if the actual outcome matches an associated expected outcome; determine a first dataset having the software test scripts that resulted in a positive outcome and excluding the software test scripts that resulted in a negative outcome; and train, based on the first dataset, a model. Other embodiments of this aspect include corresponding computer systems, apparatus, and computer programs recorded on one or more computer storage devices, each configured to perform the actions of the methods.

Devices may include one or more processors configured to: determine a model configured to respond to user queries related to a software application; determine a plurality of software test scripts; cause at least a portion of the plurality of software test scripts to be executed on the software application and cause an actual outcome; determine whether each actual outcome is a positive outcome or a negative outcome based on if the actual outcome matches an associated expected outcome; determine a first dataset having the software test scripts that resulted in a positive outcome and excluding the software test scripts that resulted in a negative outcome; for each entry in the first dataset, capture image content, where at least one image in the captured image content is a screenshot; and train, based on the first dataset, the model. Other embodiments of this aspect include corresponding computer systems, apparatus, and computer programs recorded on one or more computer storage devices, each configured to perform the actions of the methods.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example environment in which the systems and methods described herein may operate.

FIG. 2 shows example one or more platform server(s) according to the present disclosure.

FIG. 3 shows an example method for collecting training data according to the present disclosure.

FIG. 4 shows a method for training a model described herein.

FIG. 5 shows a method for training a model described herein.

FIG. 6 shows a method for training a model described herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The systems and methods described herein relate to training a model. During software development, it is often desirable to add and/or modify code executing on a customer-facing application. The additional and/or modified code (new code) may first be added to a testing environment associated with the application. A variety of tests may be created and executed associated with the new code. When a test demonstrates the new code behaving as expected, the test may be said to have a positive outcome. A subset of the variety of tests comprising a positive outcome may be used to train a model. The model may be configured to infer assistance to an end-user using the application in a manner that accesses the new code. The model may be configured to infer guidance to a developer directly accessing the new code.

The model may comprise a large language model (LLM)-based assistant. The tests may comprise a plurality of software test (language) scripts. The LLM-based assistant may be trained using the software test scripts as a training dataset. The training dataset for the LLM-based assistant may be selected based on whether software test scripts result in positive or negative results. The training datasets may only include positive results while excluding the negative results.

When adding a feature to a product with a user interface, it may be practice to write unit tests and/or automation tests to validate that the feature works as expected and does not negatively impact products and/or services. A large enterprise may have many such tests used in build processes daily. A last step in building and testing a feature may be to write an end-to-end test which, through automation testing software, may use the product from the entry point until completing the usage of the feature and passing if there are no errors. Testing frameworks may have the capability to grab image content, such as “screen shots” or video, of the product at each stage of the test. The tests may be used as context for training a model. Image content shots may be used as input to the model and/or appended to associated output from the model. The model may assist end-users who ask questions where the test demonstrates the feature, such as a model configured for customer support. The model may be configured to guide developers who need assistance with the feature, such as a model configured for a user manual for coders. The model may be trained (retrained, adjusted, etc.) at a periodic basis. The model may be trained each time a test passes. The model may be trained each day on tests that passed that day. The model may be trained on other time increments.

A smart assistant may be provided to customers of a service providing the application. The smart assistant may answer questions about features and/or products with a visual response that may be up to date and correct. Leveraging tests (such as end-to-end tests, automated tests, unit tests, etc.), the smart assistant may provide daily updates from tests yielding a positive outcome. The updates may comprise image content of products and/or a journey through the application to a feature being asked about. Context to train the model may be provided using a name associated with a test. For example, a customer may ask “How do I change my phone number on my mobile application” and may receive steps captured by an end-to-end test that verifies screens of a successful number change on the mobile application. A customer that asks about an error message the customer is seeing may receive an explanation for what reason the error message is shown derived from context of a test that verifies the error message. Code associated with a test may provide the model with context for an associated step.

Tests may be ingested for developer comments, descriptive test names, source code, test annotations, test steps, error conditions, and/or image content, such as screen shots or video. New test development may be written with model training design patterns in mind, including special annotations, metadata, tests structured for dataset creation, and more focus on developer comments for context in testing. Test annotations may include indications of if a test is customer-facing, developer-facing, etc. The model may use tests and associated data, including annotations, to train or fine-tune. The model may infer context about a test. For example, a developer may query the model about a user error associated with a customer-facing test, and the model may infer a response based, at least in part, on context provided by test annotations.

Various types of software tests may be used for model, such as large language model (LLM), training, such as fine-tuning. Regression tests may expose the model to before-and-after scenarios, highlighting how features evolve over time or how a fix a specific issue. Integration tests may show the interplay between different parts of the system, making integration tests suited for answering queries about cross-functional features or dependencies. Performance and/or load tests may capture performance constraints, timeouts, and scaling behaviors. Security and/or penetration tests may allow the model to understand common security pitfalls (Structured Query Language (SQL) injection, cross-site scripting, incorrect permissions, etc.), error messages, or recommended best practices.

Accessibility tests may equip the model to answer questions about making components accessible (such as to the hearing-impaired users, visually impaired users, colorblind users, etc.), how to fix common A11Y issues, or interpret accessibility audit findings. Localization and/or internationalization tests may help the model handle customer questions about multi-language support, region-specific configurations, or translation errors. Usability and/or user acceptance tests may provide real-world usage context and user-friendly instructions, which may improve the model’s ability to give step-by-step guidance. Exploratory and/or ad hoc tests may capture unusual issues and corner cases, improving the model’s ability to answer tough queries.

Concurrency and/or threading tests may give insight into race conditions, conflict resolutions, and/or concurrency error messages. Migration and/or upgrade tests may show how the application (system, program, etc.) transitions from older versions and offer knowledge about upgrade paths and potential pitfalls.

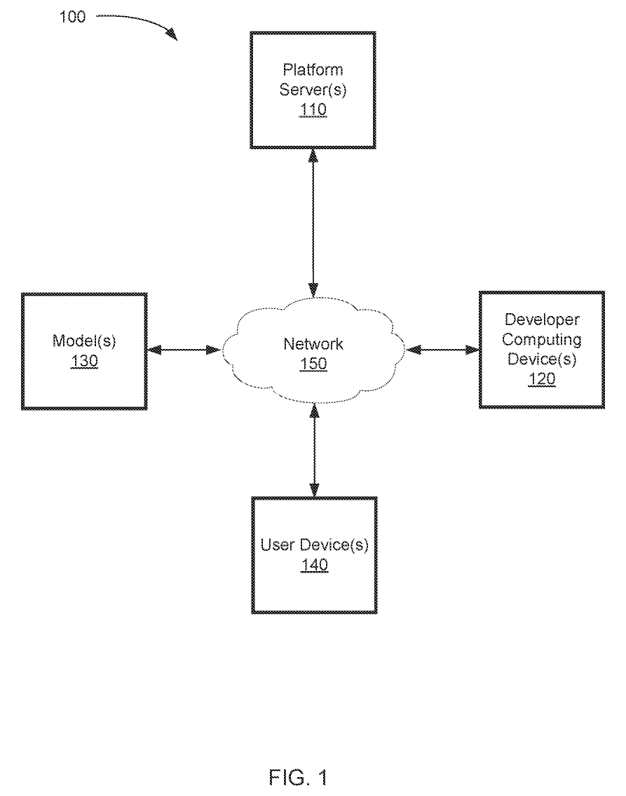

FIG. 1 may illustrate a block diagram of a system 100. The system 100 may include one or more platform server(s) 110, one or more developer computing device(s) 120, one or more model(s) 130, one or more user device(s) 140, and a network 150. These components may be interconnected to facilitate the training and deployment of a model-based assistant using software test results.

The one or more platform server(s) 110 may host a platform accessible to a user via one or more of the one or more user device(s) 140 and the network 150. The platform may comprise a content distribution network. The platform may comprise a provided service, such as providing Internet service. The one or more platform server(s) 110 may comprise one or more computing devices. The one or more platform server(s) 110 may reside in a cloud computing environment. The one or more platform server(s) 110 may be executed on distributing computing devices. The one or more platform server(s) 110 may host one or more applications comprising one or more features accessible by the one or more user device(s) 140 via the network 150. The one or more platform server(s) 110 may comprise a virtual (digital, smart, etc.) assistant to aid users with the one or more applications.

The one or more platform server(s) 110 may be accessible by developers via one or more of the one or more developer computing device(s) 120 via the network 150. The one or more applications comprising the one or more features may be accessible and/or modifiable by the one or more developer computing device(s) 120 via the network 150. The one or more platform server(s) 110 may comprise a virtual (digital, smart, etc.) guidebook (code comments, user manual, instruction manual, etc.) to assist developers in creating code for the one or more applications. The one or more platform server(s) 110 may comprise a testing environment and manage the execution of software test scripts.

The one or more platform server(s) 110 may determine if a software test script indicates that a feature behaved as expected. If a software test script reveals that a feature behaved as expected, then the one or more platform server(s) 110 may cause the software test script (and associated information) to be used as training data for the feature and for at least one model of the one or more model(s) 130. The one or more platform server(s) 110 may cause the training data to be used to train (fine-tune, etc.) the at least one of the one or more model(s) 130. The one or more platform server(s) 110 may capture visual content, such as screenshots or video, associated with software test scripts during execution. The software test scripts may be divided into stages and the one or more platform server(s) 110 may capture visual content associated with a stage. The one or more platform server(s) 110 may associate the captured visual content with the stage.

The one or more developer computing device(s) 120 may comprising one or more computing devices comprising an application to allow access to the one or more applications hosted by the one or more platform server(s) 110 via the network 150. The one or more developer computing device(s) 120 may comprise a desktop, laptop, smart phone, tablet, etc. The one or more developer computing device(s) 120 may be used by software developers and/or testers to create, modify, and/or manage the one or more applications and/or one or more features associated with the one or more applications. The one or more developer computing device(s) 120 may be used by software developers and/or testers to create, modify, and manage the software test scripts. The one or more developer computing device(s) 120 may interact with the one or more platform server(s) 110 to initiate test runs and review results. The one or more developer computing device(s) 120 may also be used to annotate or provide additional context for the captured visual content. The one or more developer computing device(s) 120 may also be used to capture visual content associated with one or more stages of a test.

The one or more model(s) 130 may comprise machine learning (ML) and/or artificial intelligence (AI) models trained and/or updated based on the software test results. The one or more model(s) 130 may be hosted on dedicated servers or cloud infrastructure. Although shown as independent, the one or more model(s) 130 may be integrated with other elements, such as the one or more platform server(s) 110. The one or more model(s) 130 may comprise large language models (LLMs). The one or more model(s) 130 may comprise small language models (SLMs). The one or more model(s) 130 may be configured to take in images as input, allowing the one or more model(s) 130 to process visual content captured during test execution and use the processed visual content in making a statistical inference. The one or more model(s) 130 may comprise a multimodal model and may output the visual content and/or an image based, at least in part, on the visual content. The one or more model(s) 130 may be specifically trained on information associated products and/or services offered through the one or more platform server(s) 110. Specialized training on the associated products and/or services may allow the one or more model(s) 130 to provide accurate and relevant responses to user queries about specific software applications, products, features, and/or services.

The one or more user device(s) 140 may comprising one or more computing devices comprising an application to allow access to the one or more applications hosted by the one or more platform server(s) 110 via the network 150. The one or more user device(s) 140 may comprise a smart television, gateway, router, smart phone, laptop, desktop, tablet, wearable computing device, etc. The one or more user device(s) 140 may be used by users (end users, customers, clients, etc.) to access and use the one or more applications and/or one or more features associated with the one or more applications. The one or more applications may comprise a virtual (digital, smart, etc.) assistant to aid users with the one or more applications. The virtual assistant may receive queries from the user, via the one or more user device(s) 140. The query may comprise visual content, such as a screen shot of an interface associated with the one or more applications. The virtual assistant may use the one or more model(s) 130 to determine a response to the query. The virtual assistant may cause the query to be inputted into the one or more model(s) 130. The virtual assistant may format the query into a prompt with a predetermined format and cause the prompt to be inputted into the one or more model(s) 130. The virtual assistant may cause the output from the one or more model(s) 130 to be presented via the one or more user device(s) 140.

The network 150 may facilitate communication between one or more platform server(s) 110, the one or more developer computing device(s) 120, the one or more model(s) 130, and/or the one or more user device(s) 140 (collectively connected components). The network 150 may allow for the transfer of test scripts, test results, model updates, user queries, responses to user queries, etc. among the connected components. The network 150 may facilitate transmission of visual content between the connected components. The network 150 may comprise a content distribution network. The network 150 may comprise a public network, such as the Internet. The network 150 may comprise a private network.

A user may access a service, such as a content streaming service, hosted on the one or more platform server(s) 110 via the network 150 with a first user device of the one or more user device(s) 140. An application executing on the first user device may facilitate access to the service. A developer via a first developer computing device of the one or more developer computing device(s) 120 and the network 150 may cause a feature, such as a rewind function, to be added to the application. The developer may need an understanding of how a media player associated with the application works before implementing the feature. To obtain the understanding, the developer may access a virtual (digital, smart, etc.) guidebook (code comments, user manual, instruction manual, etc.) on the one or more platform server(s) 110. The developer may give the virtual guidebook a query about the media player. The virtual guidebook may interface with the one or more model(s) 130 to determine a response to the query and deliver the response to the first developer computing device.

The developer may test the feature before integrating the feature into the application using a variety of software tests scripts. The software test scripts may comprise both human-readable test documentation and computer executable scripts. The human-readable test documentation may allow for easy interpretation by developers and testers, while the computer executable scripts may enable automated execution. The software test scripts may include various types of tests such as regression tests, integration tests, performance tests, security tests, accessibility tests, localization tests, usability tests, exploratory tests, concurrency tests, and migration tests. A diverse range of tests may provide comprehensive coverage of the application’s functionality and user experiences.

Each of the software test scripts may have an associated expected outcome. A subset of software test scripts may be made from the software test scripts that have an actual outcome that matches the associated expected outcome. The subset of software test scripts may be used to create training data. The software test scripts may have associated stages. For example, a first software test script used to test the rewind function may have a first stage comprising an overlay on a screen indicating that the rewind function has been engaged. A second stage of the first software test script may comprise causing content to stop playing. A third stage of the first software test script may comprise causing a position in the content to move backwards a certain number of frames per second. The expected outcome of the first software test script may be performance of each stage as expected. If actual outcome of executing the first software test script matches the expected outcome, then the first software test script may be said to have a positive outcome. If actual outcome of executing the first software test script does not match the expected outcome, then the first software test script may be said to have a negative outcome. If the first software test script has a positive outcome, then the first software test script, including any captured visual content, may be added to training data.

The training data may be used to train (adjust, fine-tune, etc.) the one or more model(s) 130. Training the one or more model(s) 130 may occur as positive outcomes for software test scripts are determined. Software test scripts with positive outcomes may be collected as a dataset and training the one or more model(s) 130 with the dataset may occur at a predetermined period (e.g., daily, biweekly, semi-monthly, etc.). The one or more model(s) 130 may be continuously updated based on new test results. As new features are added or features are modified, the corresponding test results may be used to refine responses from the one or more model(s) 130. This may ensure that the one or more model(s) 130 remain up to date with a latest version of the application.

The user may access content on the first user device via the application. The user may engage the rewind function. The rewind function may not perform as expected. The user may query a virtual assistant via a user interface on the application. The virtual assistant may use the query to create a prompt and input the prompt into one or more of the one or more model(s) 130 and receive a response. For example, the response may indicate that a source of the content does not allow the rewind function. The response may be presented via the user interface.

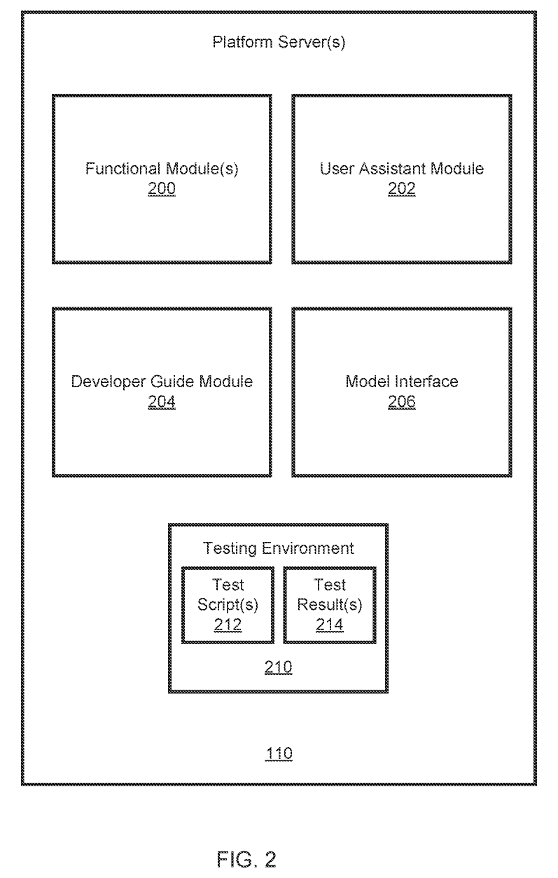

FIG. 2 illustrates a block diagram of the one or more platform server(s) 110 in FIG. 1. The platform server 110 may include various components that may work together to provide functionality for training and utilizing a model for responding to user queries about software applications. The components may be disposed in a single computing device or distributed across multiple computing devices.

The one or more platform server(s) 110 may include one or more functional module(s) 200. The one or more functional module(s) 200 may be responsible for various operations within the one or more platform server(s) 110. The one or more functional module(s) 200 may handle various tasks, such as customer-facing functionality, data processing, communication with external devices, or management of other components within the one or more platform server(s) 110. For example, at least one functional module of the one or more functional module(s) 200 may facilitate retrieval of content consumer at one of the one of more user device(s) 140 in FIG. 1.

The one or more platform server(s) 110 may comprise a user assistant module 202. The user assistant module 202 may be configured to interact with users and provide assistance based on queries. The user assistant module 202 may use the one or more model(s) 130 in FIG. 1 to determine responses to user queries about one or more applications and/or features.

The one or more platform server(s) 110 may comprise a developer (engineer, coder, programmer, etc.) guide module 204. The developer guide module 204 may provide tools and resources for developers working on software applications and/or features hosted via the one or more platform server(s) 110. The developer guide module 204 may offer documentation, code samples, or debugging assistance. The developer guide module 204 may use the one or more model(s) 130 in FIG. 1 to determine responses to user queries about one or more applications and/or features.

The one or more platform server(s) 110 may include a model interface 206. The model interface 206 may facilitate communication between the one or more model(s) 130 in FIG. 1 and other components of the one or more platform server(s) 110. The model interface 206 may handle input processing and output formatting for the one or more model(s) 130. The model interface 206 may receive data from the other components of the one or more platform server(s) 110 and may generate a prompt configured to be input for the one or more model(s) 130. The model interface 206 may receive a response from the one or more model(s) 130 and translate the response into a format consumable by the other components of the one or more platform server(s) 110. The model interface 206 may use application programming interface (API) messages to communicate with the one or more model(s) 130. The model interface 206 may cause API calls to be transmitted to the one or more model(s) 130. The model interface 206 may receive API responses from the one or more model(s) 130. The model interface 206 may facilitate visual content as input into the one or more model(s) 130. The model interface 206 may receive and/or format visual content received as output from the one or more model(s) 130.

The one or more platform server(s) 110 may comprise a testing environment 210. The testing environment 210 may provide a controlled space for executing software tests (such as software test scripts) and determine results of the executed software tests. The testing environment 210 may simulate various conditions or scenarios to evaluate the performance of software applications.

The testing environment 210 may comprise one or more test script(s) 212 (such as software test scripts). The one or more test script(s) 212 may contain instructions for automated testing of software applications. The one or more test script(s) 212 may include stages (steps, etc.) to verify specific functionalities or user interactions within the software applications. The one or more test script(s) 212 may comprise an expected result. The one or more test script(s) 212 may comprise executable code. The one or more test script(s) 212 may comprise human-readable test documentation in addition to the executable code. The documentation may provide context and explanations that can be used by the one or more model(s) 130 in FIG. 1 and/or the model interface 206 when processing the training data for the one or more model(s) 130.

The testing environment 210 may also include one or more test result(s) 214. The one or more test result(s) 214 may store the outcomes of executing the one or more test script(s) 212. When a test result matches an expect result associated with an associated test script, the test result may be defined as a positive result (outcome, etc.). When a test result does not match an expect result associated with an associated test script, the test result may be defined as a negative result. The one or more test result(s) 214 may be used to determine which test data should be included in a training dataset for the one or more model(s) 130 in FIG. 1. Data associated with a test script associated with a positive test result may be included in the training dataset. Data associated with a test script associated with a negative test result may be excluded from the training dataset.

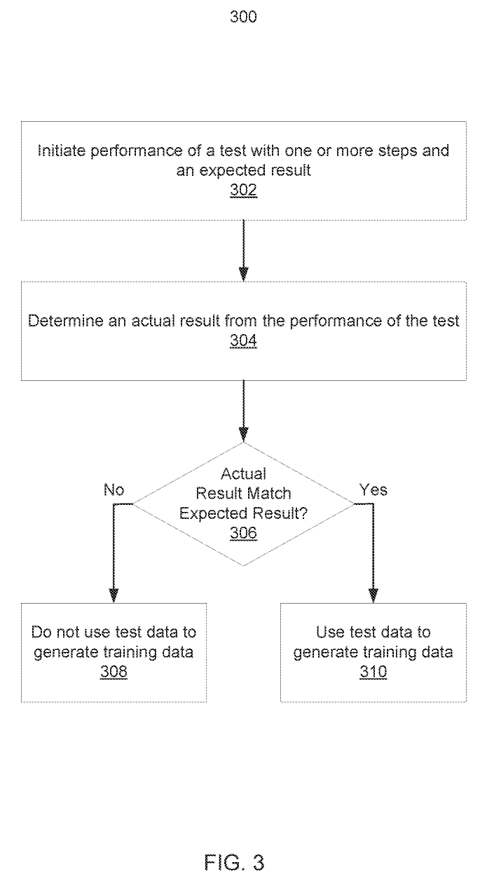

FIG. 3 illustrates a flowchart of a method 300 for processing test results and managing training data. The method 300 may be implemented by the platform server 110 to evaluate and utilize software test scripts for training a model.

Performance of a test may be initiated (block 302). The testing environment 210 in FIG. 2 may execute one or more test script(s) 212 in FIG. 2 on a software application. The one or more test script(s) 212 may include various types of tests, such as regression tests, integration tests, performance tests, security tests, accessibility tests, localization tests, usability tests, exploratory tests, concurrency tests, and migration tests. The one or more test script(s) 212 may comprise computer executable scripts that automate the testing process. The one or more test script(s) 212 may comprise an expected result. The one or more test script(s) 212 may comprise one or more stages (steps, etc.). The one or more test script(s) 212 may comprise human-readable test documentation.

An actual result from the performance of the test may be determined (block 304). The testing environment 210 may collect and analyze the outcomes of the executed test scripts. The one or more test result(s) 214 in FIG. 2 may be generated and stored for further evaluation.

A determination may be made of if the actual result matches the expected result (block 306). The actual result from block 304 may be compared with the expected result defined in the test script. The expected result may comprise a state that the actual result should match, several states one of which the actual result should match, a range within which the actual result should fail, a threshold which the actual result should satisfy, etc. Comparing the actual result with the expected result may determine whether the test was successful or if any discrepancies were found. If the actual result does not match the expected result, then the method 300 may proceed to block 308. If the actual result matches the expected result, then the method 300 may proceed to block 310.

Test data associated with the test may not be used to generate training data (block 308). The test script and associated data (test data) may be omitted (excluded, etc.) from the dataset used for training the model. Test data may include a name of the test, a type of test, developer comments, source code, test assertions, test steps, test results, visual content, etc. Excluding test data from tests associated with actual results that do not match expected results may help ensure that only successful test outcomes contribute to the model’s statistical inferences.

Test data associated with the test may be used to generate training data (block 310). The successful test script and associated data may be added to the training dataset. Test data may include a name of the test, a type of test, developer comments, source code, test assertions, test steps, test results, visual content, etc. Visual content, such as screenshots or videos, may be captured and associated with a test script. The visual content may enhance the model’s ability to provide visual responses to user queries.

For customer-facing responses, the method 300 may enable the user assistant module 202 to provide step-by-step guidance based on successful test scenarios. For example, if a customer asks how to change their phone number in an application, the model may reference a successful test script that demonstrates the process of changing a phone number, including relevant screenshots.

For developer-facing responses, the method 300 may allow the developer guide module 204 to offer insights based on test outcomes. For instance, if an engineer queries about a specific error condition, the model may reference relevant test scripts and results that encountered similar issues, providing context and potential solutions.

Although example blocks are shown, some implementations may include additional blocks, fewer blocks, different blocks, or differently arranged blocks than those depicted. Additionally, or alternatively, two or more of the blocks may be performed in parallel.

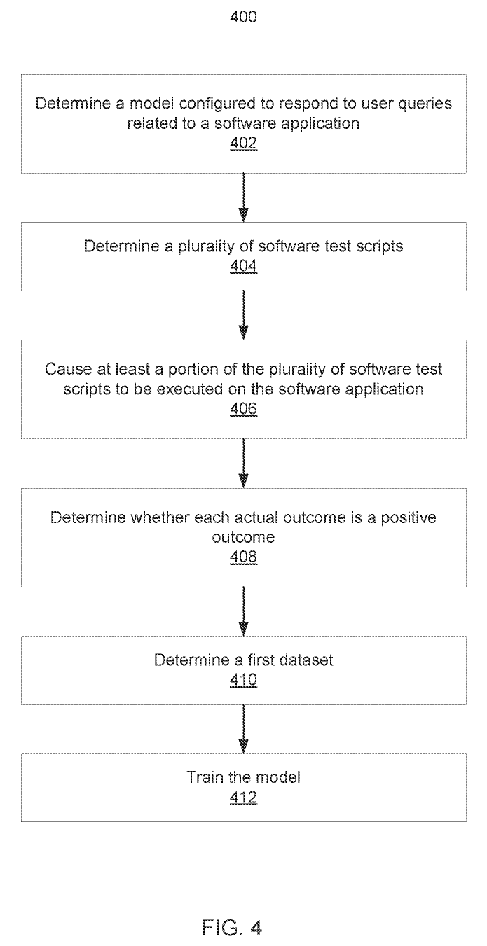

FIG. 4 illustrates a flowchart of a method 400 for training a model using software test scripts. The method 400 may be implemented by the one or more platform server(s) 110 in FIG. 1 to enhance an ability of the one or more model(s) 130 in FIG. 1 ability to respond to user queries about software applications.

A model configured to respond to user queries related to a software application may be determined (block 402). The model may be a large language model (LLM). The model may be capable of processing and generating human-like text. The model may be a small language model (SLM). The model may be configured to take in images as input. The model may be configured to take in visual content as input. A user query may comprise a question from an end-user about operation of the software application. A user query may comprise a question from a developer about operation of the software application. A user query may comprise a question from a developer about a code base associated with the software application. A user query may comprise a question about a service related to the software application.

A plurality of software test scripts may be determined (block 404). Each of the plurality of software test scripts may comprise at least one associated stage and an associated expected outcome. At least one of the software test scripts may comprise an automation test. The software test scripts may comprise various types of tests, including one or more of a regression test, integration test, performance test, load test, security test, penetration test, accessibility test, localization test, internalization test, usability test, user acceptance test, exploratory test, ad hoc test, concurrency test, threading test, migration test, and/or upgrade test. The plurality of software test scripts may comprise human-readable test documentation. The plurality of software test scripts may comprise computer executable scripts.

At least a portion of the plurality of software test scripts may be caused to be executed on the software application (block 406). Execution of the at least a portion of the plurality of software test scripts on the software application may comprise causing each of the at least a portion of the plurality of software test scripts to execute within a test environment associated with the software application and cause an actual outcome. Execution of the at least a portion of the plurality of software test scripts on the software application may comprise causing each of the at least a portion of the plurality of software test scripts to execute the at least one associated stage within a test environment associated with the software application and cause an actual outcome.

A determination may be made of whether each actual outcome is a positive outcome (block 408). A determination may be made of whether each actual outcome is a positive outcome or a negative outcome. Each actual outcome may be classified as a positive outcome if the actual outcome matches an associated expected outcome. Each actual outcome may be classified as a negative outcome if the actual outcome does not match an associated expected outcome.

A first dataset may be determined (block 410). The first dataset may comprise the software test scripts that resulted in a positive outcome. The first dataset may exclude the software test scripts that resulted in a negative outcome. At least one stage of at least one software test script associated with the first dataset may comprise associated visual content. The associated visual content may comprise a screen shot associated with the at least one stage. At least one stage of at least one software test script associated with the first dataset may comprise associated text content.

At least one entry in the first dataset may comprise an indication of at least one of the following: a first state of an environment before a time period and a second state of the environment after the time period; a function of two or more of a front-end module, a back-end module, and a module configured to make an external application programming interface (API) call; performance constraints, timeouts, or scaling behaviors; security vulnerabilities, error messages, or recommended practices; accessibility of at least one component of the software application; one or more of multi-language support, region-specific configuration, or a translation; real-world usage context or user-friendly instructions; an edge case; a race condition, a conflict resolution, or a concurrency error message; and/or a transition from an older version, an upgrade path, or a potential pitfall.

Visual content associated with a first stage associated with a first software test script associated with a first entry in the first dataset may be captured. The visual content may comprise a captured screenshot. The screenshot may depict a screen illustrative of the first stage.

The model may be trained (block 412). The model may be trained based on the first dataset. A statistical inference made by the model prior to training based on at least one user query about the software application may be different from a statistical inference made by the trained model based on the at least one user query. The training the model may comprise inputting the associated visual content into the model. The training the model may comprise inputting the associated text content into the model. The training the model may comprise finetuning the model.

The trained model may be deployed. A first user query may be received from a user device. The first user query may be related to the at least one stage. Output from the trained model may be caused to be returned to the user device. The output may comprise the visual content. The at least one user query may be received from a user device. The at least one user query may comprise at least one word in the text content. Output based on the statistical inference made by the trained model may be caused to be returned to the user device. In response to receiving a user query associated with the first stage, a response using the trained model may be provided. The response may comprise the visual content.

Output based on a first statistical inference made by the trained model may be caused to be returned to the user device. The output may be based on the at least one user query. A second statistical inference made by the model prior to the training may be different from the first statistical inference.

The user assistant module 202 may utilize this trained model to respond to user queries. When receiving a user query related to a specific test script or stage, the model may provide output that includes visual content, such as screenshots captured during the test execution.

The developer guide module 204 may also leverage the trained model to assist engineers. For instance, if an engineer submits a query containing words from the text content of a test script, the model may provide a response based on the statistical inference made after the training. This may help engineers better understand the software application and its testing processes.

Although example blocks are shown, some implementations may include additional blocks, fewer blocks, different blocks, or differently arranged blocks than those depicted. Additionally, or alternatively, two or more of the blocks may be performed in parallel.

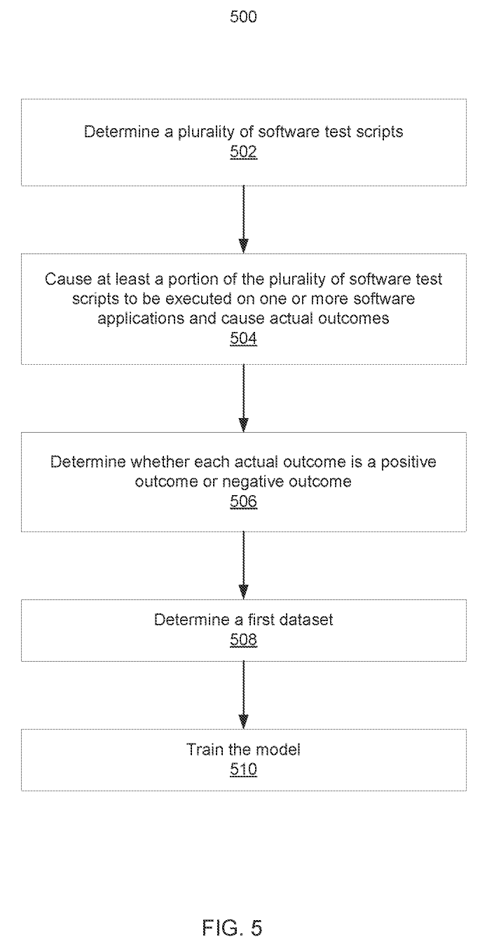

FIG. 5 illustrates a flowchart of a method 500 for training a model using software test scripts. The method 500 may be implemented by the one or more platform server(s) 110 in FIG. 1 to enhance an ability of the one or more model(s) 130 in FIG. 1 ability to respond to user queries about software applications.

A plurality of software test scripts may be determined (block 502). At least one of the software test scripts may comprise an automation test. The software test scripts may comprise various types of tests, including one or more of a regression test, integration test, performance test, load test, security test, penetration test, accessibility test, localization test, internalization test, usability test, user acceptance test, exploratory test, ad hoc test, concurrency test, threading test, migration test, and/or upgrade test. The plurality of software test scripts may comprise human-readable test documentation. The plurality of software test scripts may comprise computer executable scripts.

At least a portion of the plurality of software test scripts may be caused to be executed on one or more software applications and cause actual outcomes (block 504). Execution of the at least a portion of the plurality of software test scripts may result in one or more of a positive outcome or a negative outcome.

A determination may be made of whether each actual outcome is a positive outcome or a negative outcome (block 506). Each actual outcome may be classified as a positive outcome if the actual outcome matches an associated expected outcome. Each actual outcome may be classified as a negative outcome if the actual outcome does not match an associated expected outcome.

A first dataset may be determined (block 508). The first dataset may comprise the software test scripts that resulted in a positive outcome. The first dataset may exclude the software test scripts that resulted in a negative outcome. Visual content associated with a first software test script associated with a first entry in the first dataset may be captured. The visual content may comprise a captured screenshot. The screenshot may depict a screen illustrative of the first software test script. At least one software test script associated with the first dataset may comprise associated visual content. The associated visual content may comprise a screen shot associated with the at least one software test script. At least one software test script associated with the first dataset comprises associated text content.

At least one entry in the first dataset may comprise an indication of at least one of the following: a first state of an environment before a time period and a second state of the environment after the time period; a function of two or more of a front-end module, a back-end module, and a module configured to make an external application programming interface (API) call; performance constraints, timeouts, or scaling behaviors; security vulnerabilities, error messages, or recommended practices; accessibility of at least one component of the software application; one or more of multi-language support, region-specific configuration, or a translation; real-world usage context or user-friendly instructions; an edge case; a race condition, a conflict resolution, or a concurrency error message; and/or a transition from an older version, an upgrade path, or a potential pitfall.

A model may be trained (block 510). The model may be trained based on the first dataset. The model may be configured to respond to user queries about at least one software application of the one or more software applications. The model may be a large language model (LLM). The model may be capable of processing and generating human-like text. The model may be a small language model (SLM). The model may be configured to take in images as input. The model may be configured to take in visual content as input. The training the model may comprise pretraining the model. The training the model may comprise training an untrained model. The training the model may comprise finetuning the model. The training the model may comprise inputting the associated visual content into the model. The training the model may comprise inputting the associated text content into the model. A statistical inference made by the model prior to the training based on at least one user query about the one or more software applications may be different from a statistical inference made by the model after the training based on the at least one user query.

The model may be deployed. A first user query may be received from a user device. The first user query may be related to the at least one software test script. Output from the model may be caused to be returned to the user device. The output may comprise the visual content. The at least one user query may be received from a user device. The at least one user query may comprise at least one word in the text content. Output based on the statistical inference made by the model after the training may be caused to be returned to the user device. In response to receiving a user query associated with the first software test script, a response using the model may be provided. The response may comprise the visual content. A user query may comprise a question from an end-user about operation of the software application. A user query may comprise a question from a developer about operation of the software application. The user query may comprise a question from a developer about a code base associated with the software application.

The user assistant module 202 may utilize this updated model to respond to user queries. When receiving a user query related to a specific test script or stage, the model may provide output that includes visual content, such as screenshots captured during the test execution.

The developer guide module 204 may also leverage the updated model to assist engineers. For instance, if an engineer submits a query containing words from the text content of a test script, the model may provide a response based on the statistical inference made after the training. This may help engineers better understand the software application and its testing processes.

Although example blocks are shown, some implementations may include additional blocks, fewer blocks, different blocks, or differently arranged blocks than those depicted. Additionally, or alternatively, two or more of the blocks may be performed in parallel.

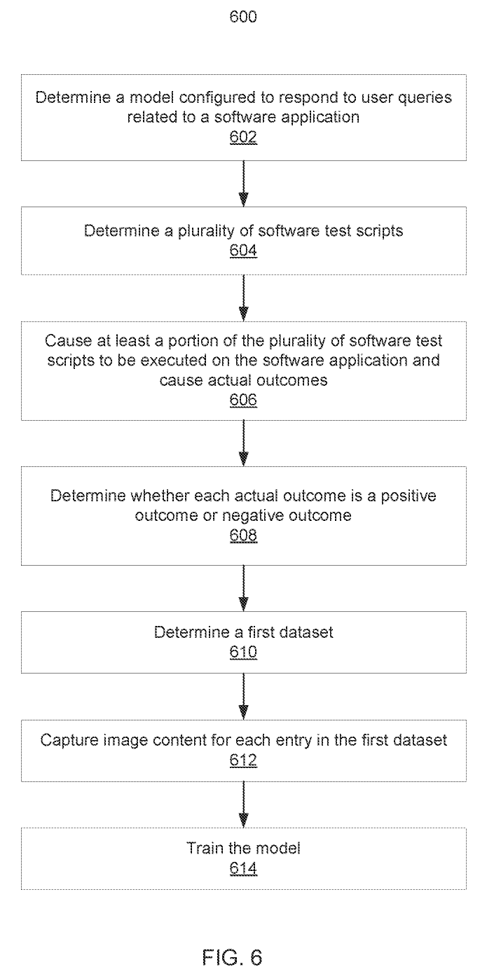

FIG. 6 illustrates a flowchart of a method 600 for training a model using software test scripts. The method 600 may be implemented by the one or more platform server(s) 110 in FIG. 1 to enhance an ability of the one or more model(s) 130 in FIG. 1 ability to respond to user queries about software applications.

A model configured to respond to user queries related to a software application may be determined (block 602). The model may be a large language model (LLM). The model may be capable of processing and generating human-like text. The model may be a small language model (SLM). The model may be configured to take in images as input. The model may be configured to take in visual content as input. A user query may comprise a question from an end-user about operation of the software application. A user query may comprise a question from a developer about operation of the software application. A user query may comprise a question from a developer about a code base associated with the software application. A user query may comprise a question about a service related to the software application.

A plurality of software test scripts may be determined (block 604). Each of the plurality of software test scripts may comprise at least one associated stage and an associated expected outcome. At least one of the software test scripts may comprise an automation test. The software test scripts may comprise various types of tests, including one or more of a regression test, integration test, performance test, load test, security test, penetration test, accessibility test, localization test, internalization test, usability test, user acceptance test, exploratory test, ad hoc test, concurrency test, threading test, migration test, and/or upgrade test. The plurality of software test scripts may comprise human-readable test documentation. The plurality of software test scripts may comprise computer executable scripts.

At least a portion of the plurality of software test scripts may be caused to be executed on the software application and cause actual outcomes (block 606). Execution of the at least a portion of the plurality of software test scripts may result in one or more of a positive outcome or a negative outcome.

A determination may be made of whether each actual outcome is a positive outcome or a negative outcome (block 608). Each actual outcome may be classified as a positive outcome if the actual outcome matches an associated expected outcome. Each actual outcome may be classified as a negative outcome if the actual outcome does not match an associated expected outcome.

A first dataset may be determined (block 610). The first dataset may comprise the software test scripts that resulted in a positive outcome. The first dataset may exclude the software test scripts that resulted in a negative outcome. At least one software test script associated with the first dataset may comprise associated text content.

At least one entry in the first dataset may comprise an indication of at least one of the following: a first state of an environment before a time period and a second state of the environment after the time period; a function of two or more of a front-end module, a back-end module, and a module configured to make an external application programming interface (API) call; performance constraints, timeouts, or scaling behaviors; security vulnerabilities, error messages, or recommended practices; accessibility of at least one component of the software application; one or more of multi-language support, region-specific configuration, or a translation; real-world usage context or user-friendly instructions; an edge case; a race condition, a conflict resolution, or a concurrency error message; and/or a transition from an older version, an upgrade path, or a potential pitfall.

Image content may be captured for each entry in the first dataset (block 612). At least one image in the captured image content may be a screenshot. At least one image in the captured image content may be a screenshot associated with at least one software test script. At least one image in the captured image content may be a screenshot associated with at least one associated stage. A portion of the image content may be captured during execution of an associated software test script. A portion of the image content may be captured after an associated software test script is determined to be in the first dataset.

The model may be trained (block 614). The model may be trained based on the first dataset. The training the model may comprise pretraining the model. The training the model may comprise training an untrained model. The training the model may comprise finetuning the model. The training the model may comprise inputting the associated text content into the model. A statistical inference made by the model prior to the training based on at least one user query about the software application may be different from a statistical inference made by the model after the training based on the at least one user query.

The model may be deployed. A first user query may be received from a user device. The first user query may be related to the at least one software test script. The first user query may be related to the at least one associated stage. Output from the model may be caused to be returned to the user device. The output may comprise the at least one image. The at least one user query may be received from a user device. The at least one user query may comprise at least one word in the text content. Output based on the statistical inference made by the model after the training may be caused to be returned to the user device. A user query may comprise a question from an end-user about operation of the software application. A user query may comprise a question from a developer about operation of the software application. The user query may comprise a question from a developer about a code base associated with the software application.

The user assistant module 202 may utilize this updated model to respond to user queries. When receiving a user query related to a specific test script or stage, the model may provide output that includes visual content, such as screenshots captured during the test execution.

The developer guide module 204 may also leverage the updated model to assist engineers. For instance, if an engineer submits a query containing words from the text content of a test script, the model may provide a response based on the statistical inference made after the training. This may help engineers better understand the software application and its testing processes.

Although example blocks are shown, some implementations may include additional blocks, fewer blocks, different blocks, or differently arranged blocks than those depicted. Additionally, or alternatively, two or more of the blocks may be performed in parallel.

### EXAMPLES

Example Clause 1: A method comprising: determining a model configured to respond to user queries related to a software application; determining a plurality of software test scripts; causing at least a portion of the plurality of software test scripts to be executed on the software application, wherein execution of the at least a portion of the plurality of software test scripts on the software application comprises causing each of the at least a portion of the plurality of software test scripts to execute within a test environment associated with the software application and cause an actual outcome; determining whether each actual outcome is a positive outcome based on if the actual outcome matches an associated expected outcome; determining a first dataset comprising the software test scripts that resulted in a positive outcome and excluding the software test scripts that resulted in a negative outcome; and training the model based on the first dataset.

Example Clause 2: The method of Example Clause 1, wherein at least one stage of at least one software test script associated with the first dataset comprises associated visual content.

Example Clause 3: The method of Example Clause 1 or Example Clause 2, wherein the training the model comprises inputting the associated visual content into the model.

Example Clause 4: The method of any one of Example Clauses 1-3, further comprising: deploying the trained model; receiving a first user query from a user device, wherein the first user query is related to the at least one stage; and causing output from the trained model to be returned to the user device, wherein the output comprises the visual content.

Example Clause 5: The method of any one of Example Clauses 1-4, wherein the associated visual content comprises a screen shot associated with the at least one stage.

Example Clause 6: The method of any one of Example Clauses 1-5, wherein at least one stage of at least one software test script associated with the first dataset comprises associated text content.

Example Clause 7: The method of any one of Example Clauses 1-6, wherein the training the model comprises inputting the associated text content into the model.

Example Clause 8: The method of any one of Example Clauses 1-7, further comprising: deploying the trained model; receiving at least one user query from a user device, wherein the at least one user query comprising at least one word in the text content; and causing output based on a first statistical inference made by the trained model to be returned to the user device, wherein the output is based on the at least one user query, and wherein a second statistical inference made by the model prior to the training is different from the first statistical inference.

Example Clause 9: The method of any one of Example Clauses 1-8, wherein at least one of the software test scripts comprises an automation test.

Example Clause 10: The method of any one of Example Clauses 1-9, wherein at least one of the software test scripts comprises a regression test.

Example Clause 11: The method of any one of Example Clauses 1-10, wherein at least one entry in the first dataset comprises an indication of a first state of an environment before a time period and a second state of the environment after the time period.

Example Clause 12: The method of any one of Example Clauses 1-11, wherein at least one of the software test scripts comprises an integration test.

Example Clause 13: The method of any one of Example Clauses 1-12, wherein at least one entry in the first dataset comprises an indication of a function of two or more of a front-end module, a back-end module, and a module configured to make an external application programming interface (API) call.

Example Clause 14: The method of any one of Example Clauses 1-13, wherein at least one of the software test scripts comprises a performance test or a load test.

Example Clause 15: The method of any one of Example Clauses 1-14, wherein at least one entry in the first dataset comprises an indication of performance constraints, timeouts, or scaling behaviors.

Example Clause 16: The method of any one of Example Clauses 1-15, wherein at least one of the software test scripts comprises a security test or a penetration test.

Example Clause 17: The method of any one of Example Clauses 1-16, wherein at least one entry in the first dataset comprises an indication of security vulnerabilities, error messages, or recommended practices.

Example Clause 18: The method of any one of Example Clauses 1-17, wherein at least one of the software test scripts comprises an accessibility test.

Example Clause 19: The method of any one of Example Clauses 1-18, wherein at least one entry in the first dataset comprises an indication of accessibility of at least one component of the software application.

Example Clause 20: The method of any one of Example Clauses 1-19, wherein at least one of the software test scripts comprises a location test or an internalization test.

Example Clause 21: The method of any one of Example Clauses 1-20, wherein at least one entry in the first dataset comprises an indication of one or more of multi-language support, region-specific configuration, or a translation.

Example Clause 22: The method of any one of Example Clauses 1-21, wherein at least one of the software test scripts comprises a usability test or a user acceptance test.

Example Clause 23: The method of any one of Example Clauses 1-22, wherein at least one entry in the first dataset comprises an indication of real-world usage context or user-friendly instructions.

Example Clause 24: The method of any one of Example Clauses 1-23, wherein at least one of the software test scripts comprises an exploratory test or an ad hoc test.

Example Clause 25: The method of any one of Example Clauses 1-24, wherein at least one entry in the first dataset comprises an indication of an edge case.

Example Clause 26: The method of any one of Example Clauses 1-25, wherein at least one of the software test scripts comprises a concurrency test or threading test.

Example Clause 27: The method of any one of Example Clauses 1-26, wherein at least one entry in the first dataset comprises an indication of at least one of a race condition, a conflict resolution, or a concurrency error message.

Example Clause 28: The method of any one of Example Clauses 1-27, wherein at least one of the software test scripts comprises a migration test or upgrade test.

Example Clause 29: The method of any one of Example Clauses 1-28, wherein at least one entry in the first dataset comprises an indication of at least one of a transition from an older version, an upgrade path, or a potential pitfall.

Example Clause 30: The method of any one of Example Clauses 1-29, wherein the model is a large language model (LLM).

Example Clause 31: The method of any one of Example Clauses 1-30, wherein the model is a small language model.

Example Clause 32: The method of any one of Example Clauses 1-31, wherein the model is configured to take in images as input.

Example Clause 33: The method of any one of Example Clauses 1-32, further comprising capturing visual content associated with a first stage associated with a first software test script associated with a first entry in the first dataset.

Example Clause 34: The method of any one of Example Clauses 1-33, wherein the visual content comprises a captured screenshot, and wherein the screenshot depicts a screen illustrative of the first stage.

Example Clause 35: The method of any one of Example Clauses 1-34, further comprising deploying the trained model.

Example Clause 36: The method of any one of Example Clauses 1-35, further comprising, in response to receiving a user query associated with the first stage, providing a response using the trained model, wherein the response comprises the visual content.

Example Clause 37: The method of any one of Example Clauses 1-36, wherein the training the model comprises finetuning the model.

Example Clause 38: The method of any one of Example Clauses 1-37, wherein the plurality of software test scripts comprises human-readable test documentation.

Example Clause 39: The method of any one of Example Clauses 1-38, wherein the plurality of software test scripts comprises computer executable scripts.

Example Clause 40: A method comprising: determining a plurality of software test scripts; causing at least a portion of the plurality of software test scripts to be executed on one or more software applications and causing actual outcomes; determining whether each actual outcome is a positive outcome or a negative outcome based on if each actual outcome matches an associated expected outcome; determining a first dataset comprising the software test scripts that resulted in a positive outcome and excluding the software test scripts that resulted in a negative outcome; and training, based on the first dataset, a model.

Example Clause 41: The method of Example Clause 40, wherein at least one software test script associated with the first dataset comprises associated visual content.

Example Clause 42: The method of Example Clause 40 or Example Clause 41, wherein the training the model comprises inputting the associated visual content into the model.

Example Clause 43: The method of any one of Example Clauses 40-42, further comprising: deploying the model; receiving a first user query from a user device, wherein the first user query is related to the at least one software test script; and causing output from the model to be returned to the user device, wherein the output comprises the visual content.

Example Clause 44: The method of any one of Example Clauses 40-43, wherein the associated visual content comprises a screen shot associated with the at least one software test script.

Example Clause 45: The method of any one of Example Clauses 40-44, wherein at least one software test script associated with the first dataset comprises associated text content.

Example Clause 46: The method of any one of Example Clauses 40-45, wherein the training the model comprises inputting the associated text content into the model, and wherein a statistical inference made by the model prior to the training based on at least one user query about the one or more software applications is different from a statistical inference made by the model after the training based on the at least one user query.

Example Clause 47: The method of any one of Example Clauses 40-46, further comprising: deploying the model; receiving the at least one user query from a user device, wherein the at least one user query comprising at least one word in the text content; and causing output based on the statistical inference made by the model after the training to be returned to the user device.

Example Clause 48: The method of any one of Example Clauses 40-47, wherein at least one of the software test scripts comprises an automation test.

Example Clause 49: The method of any one of Example Clauses 40-48, wherein at least one of the software test scripts comprises a regression test.

Example Clause 50: The method of any one of Example Clauses 40-49, wherein at least one entry in the first dataset comprises an indication of a first state of an environment before a time period and a second state of the environment after the time period.

Example Clause 51: The method of any one of Example Clauses 40-50, wherein at least one of the software test scripts comprises an integration test.

Example Clause 52: The method of any one of Example Clauses 40-51, wherein at least one entry in the first dataset comprises an indication of a function of two or more of a front-end module, a back-end module, and a module configured to make an external application programming interface (API) call.

Example Clause 53: The method of any one of Example Clauses 40-52, wherein at least one of the software test scripts comprises a performance test or a load test.

Example Clause 54: The method of any one of Example Clauses 40-53, wherein at least one entry in the first dataset comprises an indication of performance constraints, timeouts, or scaling behaviors.

Example Clause 55: The method of any one of Example Clauses 40-54, wherein at least one of the software test scripts comprises a security test or a penetration test.

Example Clause 56: The method of any one of Example Clauses 40-55, wherein at least one entry in the first dataset comprises an indication of security vulnerabilities, error messages, or recommended practices.

Example Clause 57: The method of any one of Example Clauses 40-56, wherein at least one of the software test scripts comprises an accessibility test.

Example Clause 58: The method of any one of Example Clauses 40-57, wherein at least one entry in the first dataset comprises an indication of accessibility of at least one component of the one or more software applications.

Example Clause 59: The method of any one of Example Clauses 40-58, wherein at least one of the software test scripts comprises a location test or an internalization test.

Example Clause 60: The method of any one of Example Clauses 40-59, wherein at least one entry in the first dataset comprises an indication of one or more of multi-language support, region-specific configuration, or a translation.

Example Clause 61: The method of any one of Example Clauses 40-60, wherein at least one of the software test scripts comprises a usability test or a user acceptance test.

Example Clause 62: The method of any one of Example Clauses 40-61, wherein at least one entry in the first dataset comprises an indication of real-world usage context or user-friendly instructions.

Example Clause 63: The method of any one of Example Clauses 40-62, wherein at least one of the software test scripts comprises an exploratory test or an ad hoc test.

Example Clause 64: The method of any one of Example Clauses 40-63, wherein at least one entry in the first dataset comprises an indication of an edge case.

Example Clause 65: The method of any one of Example Clauses 40-64, wherein at least one of the software test scripts comprises a concurrency test or threading test.

Example Clause 66: The method of any one of Example Clauses 40-65, wherein at least one entry in the first dataset comprises an indication of at least one of a race condition, a conflict resolution, or a concurrency error message.

Example Clause 67: The method of any one of Example Clauses 40-66, wherein at least one of the software test scripts comprises a migration test or upgrade test.

Example Clause 68: The method of any one of Example Clauses 40-67, wherein at least one entry in the first dataset comprises an indication of at least one of a transition from an older version, an upgrade path, or a potential pitfall.

Example Clause 69: The method of any one of Example Clauses 40-68, wherein the model is a large language model (LLM).

Example Clause 70: The method of any one of Example Clauses 40-69, wherein the model is a small language model.

Example Clause 71: The method of any one of Example Clauses 40-70, wherein the model is configured to take in images as input.

Example Clause 72: The method of any one of Example Clauses 40-71, further comprising capturing visual content associated with a first software test script associated with a first entry in the first dataset.

Example Clause 73: The method of any one of Example Clauses 40-72, wherein the visual content comprises a captured screenshot, and wherein the screenshot depicts a screen illustrative of the first software test script.

Example Clause 74: The method of any one of Example Clauses 40-73, further comprising deploying the model.

Example Clause 75: The method of any one of Example Clauses 40-74, further comprising, in response to receiving a user query associated with the first software test script, providing a response using the model, wherein the response comprises the visual content.

Example Clause 76: The method of any one of Example Clauses 40-75, wherein the training the model comprises pretraining the model.

Example Clause 77: The method of any one of Example Clauses 40-76, wherein the training the model comprises finetuning the model.

Example Clause 78: The method of any one of Example Clauses 40-77, wherein the plurality of software test scripts comprises human-readable test documentation.

Example Clause 79: The method of any one of Example Clauses 40-78, wherein the plurality of software test scripts comprises computer executable scripts.

Example Clause 80: A method comprising: determining a model configured to respond to user queries related to a software application; determining a plurality of software test scripts; causing at least a portion of the plurality of software test scripts to be executed on the software application and cause an actual outcome; determining whether each actual outcome is a positive outcome or a negative outcome based on if each actual outcome matches an associated expected outcome; determining a first dataset comprising the software test scripts that resulted in a positive outcome and excluding the software test scripts that resulted in a negative outcome; for each entry in the first dataset, capturing image content, wherein at least one image in the captured image content is a screenshot associated with at least one software test script; and training, based on the first dataset, the model.

Example Clause 81: The method of Example Clause 80, further comprising: deploying the model; receiving a first user query from a user device, wherein the first user query is related to the at least one software test script; and causing output from the model to be returned to the user device, wherein the output comprises the at least one image.

Example Clause 82: The method of Example Clause 80 or Example Clause 81, wherein at least one software test script associated with the first dataset comprises associated text content.

Example Clause 83: The method of any one of Example Clauses 80-82, wherein the training the model comprises inputting the associated text content into the model, and wherein a statistical inference made by the model prior to the training based on at least one user query about the software application is different from a statistical inference made by the model after the training based on the at least one user query.

Example Clause 84: The method of any one of Example Clauses 80-83, further comprising: deploying the model; receiving the at least one user query from a user device, wherein the at least one user query comprising at least one word in the text content; and causing output based on the statistical inference made after the training to be returned to the user device.

Example Clause 85: The method of any one of Example Clauses 80-84, wherein at least one of the software test scripts comprises an automation test.

Example Clause 86: The method of any one of Example Clauses 80-85, wherein at least one of the software test scripts comprises a regression test.

Example Clause 87: The method of any one of Example Clauses 80-86, wherein at least one entry in the first dataset comprises an indication of a first state of an environment before a time period and a second state of the environment after the time period.

Example Clause 88: The method of any one of Example Clauses 80-87, wherein at least one of the software test scripts comprises an integration test.

Example Clause 89: The method of any one of Example Clauses 80-88, wherein at least one entry in the first dataset comprises an indication of a function of two or more of a front-end module, a back-end module, and a module configured to make an external application programming interface (API) call.

Example Clause 90: The method of any one of Example Clauses 80-89, wherein at least one of the software test scripts comprises a performance test or a load test.

Example Clause 91: The method of any one of Example Clauses 80-90, wherein at least one entry in the first dataset comprises an indication of performance constraints, timeouts, or scaling behaviors.

Example Clause 92: The method of any one of Example Clauses 80-91, wherein at least one of the software test scripts comprises a security test or a penetration test.

Example Clause 93: The method of any one of Example Clauses 80-92, wherein at least one entry in the first dataset comprises an indication of security vulnerabilities, error messages, or recommended practices.

Example Clause 94: The method of any one of Example Clauses 80-93, wherein at least one of the software test scripts comprises an accessibility test.

Example Clause 95: The method of any one of Example Clauses 80-94, wherein at least one entry in the first dataset comprises an indication of accessibility of at least one component of the software application.

Example Clause 96: The method of any one of Example Clauses 80-95, wherein at least one of the software test scripts comprises a location test or an internalization test.

Example Clause 97: The method of any one of Example Clauses 80-96, wherein at least one entry in the first dataset comprises an indication of one or more of multi-language support, region-specific configuration, or a translation.

Example Clause 98: The method of any one of Example Clauses 80-97, wherein at least one of the software test scripts comprises a usability test or a user acceptance test.

Example Clause 99: The method of any one of Example Clauses 80-98, wherein at least one entry in the first dataset comprises an indication of real-world usage context or user-friendly instructions.

Example Clause 100: The method of any one of Example Clauses 80-99, wherein at least one of the software test scripts comprises an exploratory test or an ad hoc test.

Example Clause 101: The method of any one of Example Clauses 80-100, wherein at least one entry in the first dataset comprises an indication of an edge case.

Example Clause 102: The method of any one of Example Clauses 80-101, wherein at least one of the software test scripts comprises a concurrency test or threading test.

Example Clause 103: The method of any one of Example Clauses 80-102, wherein at least one entry in the first dataset comprises an indication of at least one of a race condition, a conflict resolution, or a concurrency error message.

Example Clause 104: The method of any one of Example Clauses 80-103, wherein at least one of the software test scripts comprises a migration test or upgrade test.

Example Clause 105: The method of any one of Example Clauses 80-104, wherein at least one entry in the first dataset comprises an indication of at least one of a transition from an older version, an upgrade path, or a potential pitfall.

Example Clause 106: The method of any one of Example Clauses 80-105, wherein the model is a large language model (LLM).

Example Clause 107: The method of any one of Example Clauses 80-106, wherein the model is a small language model.

Example Clause 108: The method of any one of Example Clauses 80-107, wherein the model is configured to take in images as input.

Example Clause 109: The method of any one of Example Clauses 80-108, further comprising capturing visual content associated with a first software test script associated with a first entry in the first dataset.

Example Clause 110: The method of any one of Example Clauses 80-109, wherein the visual content comprises a captured screenshot, and wherein the screenshot depicts a screen illustrative of the first software test script.

Example Clause 111: The method of any one of Example Clauses 80-110, further comprising deploying the model.

Example Clause 112: The method of any one of Example Clauses 80-111, further comprising, in response to receiving a user query associated with the first software test script, providing a response using the model, wherein the response comprises the visual content.

Example Clause 113: The method of any one of Example Clauses 80-112, wherein the training the model comprises pretraining the model.

Example Clause 114: The method of any one of Example Clauses 80-113, wherein the training the model comprises finetuning the model.

Example Clause 115: The method of any one of Example Clauses 80-114, wherein the plurality of software test scripts comprises human-readable test documentation.

Example Clause 116: The method of any one of Example Clauses 80-115, wherein the plurality of software test scripts comprises computer executable scripts.

Example Clause 117: A device comprising: one or more processors configured to: determine a model configured to respond to user queries related to a software application; determine a plurality of software test scripts; cause at least a portion of the plurality of software test scripts to be executed on the software application, wherein execution of the at least a portion of the plurality of software test scripts on the software application comprises causing each of the at least a portion of the plurality of software test scripts to execute within a test environment associated with the software application and cause an actual outcome, determine whether each actual outcome is a positive outcome based on if the actual outcome matches the associated expected outcome; determine a first dataset comprising the software test scripts that resulted in a positive outcome and excluding the software test scripts that resulted in a negative outcome; and train the model based on the first dataset.

Example Clause 118: The device of Example Clause 117, wherein at least one stage of at least one software test script associated with the first dataset comprises associated visual content.

Example Clause 119: The device of Example Clause 117 or Example Clause 118, wherein the one or more processors, when the training the model, are configured to input the associated visual content into the model.

Example Clause 120: The device of any one of Example Clauses 117-119, wherein the one or more processors are further configured to: deploy the trained model; receive a first user query from a user device, wherein the first user query is related to the at least one stage; and cause output from the trained model to be returned to the user device, wherein the output comprises the visual content.

Example Clause 121: The device of any one of Example Clauses 117-120, wherein the associated visual content comprises a screen shot associated with the at least one stage.

Example Clause 122: The device of any one of Example Clauses 117-121, wherein at least one stage of at least one software test script associated with the first dataset comprises associated text content.

Example Clause 123: The device of any one of Example Clauses 117-122, wherein the one or more processors, when the training the model, are configured to input the associated text content into the model.

Example Clause 124: The device of any one of Example Clauses 117-123, wherein the one or more processors are further configured to: deploy the trained model; receive at least one user query from a user device, wherein the at least one user query comprising at least one word in the text content; and cause output based on a first statistical inference made by the trained model to be returned to the user device, wherein the output is based on the at least one user query, and wherein a second statistical inference made by the model prior to the training is different from the first statistical inference.

Example Clause 125: The device of any one of Example Clauses 117-124, wherein at least one of the software test scripts comprises an automation test.

Example Clause 126: The device of any one of Example Clauses 117-125, wherein at least one of the software test scripts comprises a regression test.

Example Clause 127: The device of any one of Example Clauses 117-126, wherein at least one entry in the first dataset comprises an indication of a first state of an environment before a time period and a second state of the environment after the time period.

Example Clause 128: The device of any one of Example Clauses 117-127, wherein at least one of the software test scripts comprises an integration test.

Example Clause 129: The device of any one of Example Clauses 117-128, wherein at least one entry in the first dataset comprises an indication of a function of two or more of a front-end module, a back-end module, and a module configured to make an external application programming interface (API) call.

Example Clause 130: The device of any one of Example Clauses 117-129, wherein at least one of the software test scripts comprises a performance test or a load test.

Example Clause 131: The device of any one of Example Clauses 117-130, wherein at least one entry in the first dataset comprises an indication of performance constraints, timeouts, or scaling behaviors.

Example Clause 132: The device of any one of Example Clauses 117-131, wherein at least one of the software test scripts comprises a security test or a penetration test.

Example Clause 133: The device of any one of Example Clauses 117-132, wherein at least one entry in the first dataset comprises an indication of security vulnerabilities, error messages, or recommended practices.

Example Clause 134: The device of any one of Example Clauses 117-133, wherein at least one of the software test scripts comprises an accessibility test.

Example Clause 135: The device of any one of Example Clauses 117-134, wherein at least one entry in the first dataset comprises an indication of accessibility of at least one component of the software application.

Example Clause 136: The device of any one of Example Clauses 117-135, wherein at least one of the software test scripts comprises a location test or an internalization test.

Example Clause 137: The device of any one of Example Clauses 117-136, wherein at least one entry in the first dataset comprises an indication of one or more of multi-language support, region-specific configuration, or a translation.

Example Clause 138: The device of any one of Example Clauses 117-137, wherein at least one of the software test scripts comprises a usability test or a user acceptance test.

Example Clause 139: The device of any one of Example Clauses 117-138, wherein at least one entry in the first dataset comprises an indication of real-world usage context or user-friendly instructions.

Example Clause 140: The device of any one of Example Clauses 117-139, wherein at least one of the software test scripts comprises an exploratory test or an ad hoc test.

Example Clause 141: The device of any one of Example Clauses 117-140, wherein at least one entry in the first dataset comprises an indication of an edge case.

Example Clause 142: The device of any one of Example Clauses 117-141, wherein at least one of the software test scripts comprises a concurrency test or threading test.

Example Clause 143: The device of any one of Example Clauses 117-142, wherein at least one entry in the first dataset comprises an indication of at least one of a race condition, a conflict resolution, or a concurrency error message.

Example Clause 144: The device of any one of Example Clauses 117-143, wherein at least one of the software test scripts comprises a migration test or upgrade test.

Example Clause 145: The device of any one of Example Clauses 117-144, wherein at least one entry in the first dataset comprises an indication of at least one of a transition from an older version, an upgrade path, or a potential pitfall.

Example Clause 146: The device of any one of Example Clauses 117-145, wherein the model is a large language model (LLM).

Example Clause 147: The device of any one of Example Clauses 117-146, wherein the model is a small language model.

Example Clause 148: The device of any one of Example Clauses 117-147, wherein the model is configured to take in images as input.

Example Clause 149: The device of any one of Example Clauses 117-148, wherein the one or more processors are further configured to: capture visual content associated with a first stage associated with a first software test script associated with a first entry in the first dataset.

Example Clause 150: The device of any one of Example Clauses 117-149, wherein the visual content comprises a captured screenshot, and wherein the screenshot depicts a screen illustrative of the first stage.

Example Clause 151: The device of any one of Example Clauses 117-150, wherein the one or more processors are further configured to: deploy the trained model.

Example Clause 152: The device of any one of Example Clauses 117-151, wherein the one or more processors are further configured to: in response to receiving a user query associated with the first stage, provide a response using the trained model, wherein the response comprises the visual content.

Example Clause 153: The device of any one of Example Clauses 117-152, wherein the one or more processors, when the training the model, are configured to finetune the model.

Example Clause 154: The device of any one of Example Clauses 117-153, wherein the plurality of software test scripts comprises human-readable test documentation.

Example Clause 155: The device of any one of Example Clauses 117-154, wherein the plurality of software test scripts comprises computer executable scripts.

Example Clause 156: A device comprising: one or more processors configured to: determine a plurality of software test scripts; cause at least a portion of the plurality of software test scripts to be executed on one or more software applications and cause actual outcomes; determine whether each actual outcome is a positive outcome or a negative outcome based on if each actual outcome matches an associated expected outcome; determine a first dataset comprising the software test scripts that resulted in a positive outcome and excluding the software test scripts that resulted in a negative outcome; and train, based on the first dataset, a model.

Example Clause 157: The device of Example Clause 156, wherein at least one software test script associated with the first dataset comprises associated visual content.

Example Clause 158: The device of Example Clause 156 or Example Clause 157, wherein the one or more processors, when the training the model, are configured to input the associated visual content into the model.

Example Clause 159: The device of any one of Example Clauses 156-158, wherein the one or more processors are further configured to: deploy the model; receive a first user query from a user device, wherein the first user query is related to the at least one software test script; and cause output from the model to be returned to the user device, wherein the output comprises the visual content.

Example Clause 160: The device of any one of Example Clauses 156-159, wherein the associated visual content comprises a screen shot associated with the at least one software test script.

Example Clause 161: The device of any one of Example Clauses 156-160, wherein at least one software test script associated with the first dataset comprises associated text content.

Example Clause 162: The device of any one of Example Clauses 156-161, wherein the one or more processors, when the training the model, are configured to input the associated text content into the model, and wherein a statistical inference made by the model prior to the training based on at least one user query about the one or more software applications is different from a statistical inference made by the model after the training based on the at least one user query.

Example Clause 163: The device of any one of Example Clauses 156-162, wherein the one or more processors are further configured to: deploy the model; receive the at least one user query from a user device, wherein the at least one user query comprising at least one word in the text content; and cause output based on the statistical inference made by the model after the training to be returned to the user device.

Example Clause 164: The device of any one of Example Clauses 156-163, wherein at least one of the software test scripts comprises an automation test.

Example Clause 165: The device of any one of Example Clauses 156-164, wherein at least one of the software test scripts comprises a regression test.

Example Clause 166: The device of any one of Example Clauses 156-165, wherein at least one entry in the first dataset comprises an indication of a first state of an environment before a time period and a second state of the environment after the time period.

Example Clause 167: The device of any one of Example Clauses 156-166, wherein at least one of the software test scripts comprises an integration test.

Example Clause 168: The device of any one of Example Clauses 156-167, wherein at least one entry in the first dataset comprises an indication of a function of two or more of a front-end module, a back-end module, and a module configured to make an external application programming interface (API) call.

Example Clause 169: The device of any one of Example Clauses 156-168, wherein at least one of the software test scripts comprises a performance test or a load test.

Example Clause 170: The device of any one of Example Clauses 156-169, wherein at least one entry in the first dataset comprises an indication of performance constraints, timeouts, or scaling behaviors.

Example Clause 171: The device of any one of Example Clauses 156-170, wherein at least one of the software test scripts comprises a security test or a penetration test.

Example Clause 172: The device of any one of Example Clauses 156-171, wherein at least one entry in the first dataset comprises an indication of security vulnerabilities, error messages, or recommended practices.

Example Clause 173: The device of any one of Example Clauses 156-172, wherein at least one of the software test scripts comprises an accessibility test.

Example Clause 174: The device of any one of Example Clauses 156-173, wherein at least one entry in the first dataset comprises an indication of accessibility of at least one component of the one or more software applications.

Example Clause 175: The device of any one of Example Clauses 156-174, wherein at least one of the software test scripts comprises a location test or an internalization test.

Example Clause 176: The device of any one of Example Clauses 156-175, wherein at least one entry in the first dataset comprises an indication of one or more of multi-language support, region-specific configuration, or a translation.

Example Clause 177: The device of any one of Example Clauses 156-176, wherein at least one of the software test scripts comprises a usability test or a user acceptance test.

Example Clause 178: The device of any one of Example Clauses 156-177, wherein at least one entry in the first dataset comprises an indication of real-world usage context or user-friendly instructions.

Example Clause 179: The device of any one of Example Clauses 156-178, wherein at least one of the software test scripts comprises an exploratory test or an ad hoc test.

Example Clause 180: The device of any one of Example Clauses 156-179, wherein at least one entry in the first dataset comprises an indication of an edge case.

Example Clause 181: The device of any one of Example Clauses 156-180, wherein at least one of the software test scripts comprises a concurrency test or threading test.

Example Clause 182: The device of any one of Example Clauses 156-181, wherein at least one entry in the first dataset comprises an indication of at least one of a race condition, a conflict resolution, or a concurrency error message.

Example Clause 183: The device of any one of Example Clauses 156-182, wherein at least one of the software test scripts comprises a migration test or upgrade test.

Example Clause 184: The device of any one of Example Clauses 156-183, wherein at least one entry in the first dataset comprises an indication of at least one of a transition from an older version, an upgrade path, or a potential pitfall.

Example Clause 185: The device of any one of Example Clauses 156-184, wherein the model is a large language model (LLM).

Example Clause 186: The device of any one of Example Clauses 156-185, wherein the model is a small language model.

Example Clause 187: The device of any one of Example Clauses 156-186, wherein the model is configured to take in images as input.

Example Clause 188: The device of any one of Example Clauses 156-187, wherein the one or more processors are further configured to: capture visual content associated with a first software test script associated with a first entry in the first dataset.

Example Clause 189: The device of any one of Example Clauses 156-188, wherein the visual content comprises a captured screenshot, and wherein the screenshot depicts a screen illustrative of the first software test script.

Example Clause 190: The device of any one of Example Clauses 156-189, wherein the one or more processors are further configured to: deploy the model.

Example Clause 191: The device of any one of Example Clauses 156-190, wherein the one or more processors are further configured to: in response to receiving a user query associated with the first software test script, provide a response using the model, wherein the response comprises the visual content.

Example Clause 192: The device of any one of Example Clauses 156-191, wherein the one or more processors, when the training the model, are configured to pretrain the model.

Example Clause 193: The device of any one of Example Clauses 156-192, wherein the one or more processors, when the training the model, are configured to finetune the model.

Example Clause 194: The device of any one of Example Clauses 156-193, wherein the plurality of software test scripts comprises human-readable test documentation.

Example Clause 195: The device of any one of Example Clauses 156-194, wherein the plurality of software test scripts comprises computer executable scripts.

Example Clause 196: A device comprising: one or more processors configured to: determine a model configured to respond to user queries related to a software application; determine a plurality of software test scripts; cause at least a portion of the plurality of software test scripts to be executed on the software application and cause an actual outcome; determine whether each outcome is a positive outcome or a negative outcome based on if each actual outcome matches an associated expected outcome; determine a first dataset comprising the software test scripts that resulted in a positive outcome and excluding the software test scripts that resulted in a negative outcome; for each entry in the first dataset, capture image content, wherein at least one image in the captured image content is a screenshot associated with at least one software test script; and train, based on the first dataset, the model.

Example Clause 197: The device of Example Clause 196, wherein the one or more processors are further configured to: deploy the model; receive a first user query from a user device, wherein the first user query is related to the at least one software test script; and cause output from the model to be returned to the user device, wherein the output comprises the at least one image.

Example Clause 198: The device of Example Clause 196 or Example Clause 197, wherein at least one software test script associated with the first dataset comprises associated text content.

Example Clause 199: The device of any one of Example Clauses 196-198, wherein the one or more processors, when the training the model, are configured to input the associated text content into the model, and wherein a statistical inference made by the model prior to the training based on at least one user query about the software application is different from a statistical inference made by the model after the training based on the at least one user query.

Example Clause 200: The device of any one of Example Clauses 196-199, wherein the one or more processors are further configured to: deploy the model; receive the at least one user query from a user device, wherein the at least one user query comprising at least one word in the text content; and causing output based on the statistical inference made after the training to be returned to the user device.

Example Clause 201: The device of any one of Example Clauses 196-200, wherein at least one of the software test scripts comprises an automation test.

Example Clause 202: The device of any one of Example Clauses 196-201, wherein at least one of the software test scripts comprises a regression test.

Example Clause 203: The device of any one of Example Clauses 196-202, wherein at least one entry in the first dataset comprises an indication of a first state of an environment before a time period and a second state of the environment after the time period.

Example Clause 204: The device of any one of Example Clauses 196-203, wherein at least one of the software test scripts comprises an integration test.

Example Clause 205: The device of any one of Example Clauses 196-204, wherein at least one entry in the first dataset comprises an indication of a function of two or more of a front-end module, a back-end module, and a module configured to make an external application programming interface (API) call.

Example Clause 206: The device of any one of Example Clauses 196-205, wherein at least one of the software test scripts comprises a performance test or a load test.

Example Clause 207: The device of any one of Example Clauses 196-206, wherein at least one entry in the first dataset comprises an indication of performance constraints, timeouts, or scaling behaviors.

Example Clause 208: The device of any one of Example Clauses 196-207, wherein at least one of the software test scripts comprises a security test or a penetration test.

Example Clause 209: The device of any one of Example Clauses 196-208, wherein at least one entry in the first dataset comprises an indication of security vulnerabilities, error messages, or recommended practices.

Example Clause 210: The device of any one of Example Clauses 196-209, wherein at least one of the software test scripts comprises an accessibility test.

Example Clause 211: The device of any one of Example Clauses 196-210, wherein at least one entry in the first dataset comprises an indication of accessibility of at least one component of the software application.

Example Clause 212: The device of any one of Example Clauses 196-211, wherein at least one of the software test scripts comprises a location test or an internalization test.

Example Clause 213: The device of any one of Example Clauses 196-212, wherein at least one entry in the first dataset comprises an indication of one or more of multi-language support, region-specific configuration, or a translation.

Example Clause 214: The device of any one of Example Clauses 196-213, wherein at least one of the software test scripts comprises a usability test or a user acceptance test.

Example Clause 215: The device of any one of Example Clauses 196-214, wherein at least one entry in the first dataset comprises an indication of real-world usage context or user-friendly instructions.

Example Clause 216: The device of any one of Example Clauses 196-215, wherein at least one of the software test scripts comprises an exploratory test or an ad hoc test.

Example Clause 217: The device of any one of Example Clauses 196-216, wherein at least one entry in the first dataset comprises an indication of an edge case.

Example Clause 218: The device of any one of Example Clauses 196-217, wherein at least one of the software test scripts comprises a concurrency test or threading test.

Example Clause 219: The device of any one of Example Clauses 196-218, wherein at least one entry in the first dataset comprises an indication of at least one of a race condition, a conflict resolution, or a concurrency error message.

Example Clause 220: The device of any one of Example Clauses 196-219, wherein at least one of the software test scripts comprises a migration test or upgrade test.

Example Clause 221: The device of any one of Example Clauses 196-220, wherein at least one entry in the first dataset comprises an indication of at least one of a transition from an older version, an upgrade path, or a potential pitfall.

Example Clause 222: The device of any one of Example Clauses 196-221, wherein the model is a large language model (LLM).

Example Clause 223: The device of any one of Example Clauses 196-222, wherein the model is a small language model.

Example Clause 224: The device of any one of Example Clauses 196-223, wherein the model is configured to take in images as input.

Example Clause 225: The device of any one of Example Clauses 196-224, wherein the one or more processors, when the training the model, are configured to pretrain the model.

Example Clause 226: The device of any one of Example Clauses 196-225, wherein the one or more processors, when the training the model, are configured to finetune the model.

Example Clause 227: The device of any one of Example Clauses 196-226, wherein the plurality of software test scripts comprises human-readable test documentation.

Example Clause 228: The device of any one of Example Clauses 196-227, wherein the plurality of software test scripts comprises computer executable scripts.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
determining a model configured to respond to user queries related to a software application;
determining a plurality of software test scripts;
causing at least a portion of the plurality of software test scripts to be executed on the software application, wherein execution of the at least a portion of the plurality of software test scripts on the software application comprises causing each of the at least a portion of the plurality of software test scripts to execute within a test environment associated with the software application and cause an actual outcome;
determining whether each actual outcome is a positive outcome based on if each actual outcome matches an associated expected outcome;
determining a first dataset comprising the software test scripts that resulted in a positive outcome and excluding the software test scripts that resulted in a negative outcome; and
training the model based on the first dataset.

2. The method of claim 1, wherein at least one stage of at least one software test script associated with the first dataset comprises associated visual content.

3. The method of claim 2, wherein the training the model comprises inputting the associated visual content into the model.

4. The method of claim 3, further comprising:
deploying the trained model;
receiving a first user query from a user device, wherein the first user query is related to the at least one stage; and
causing output from the trained model to be returned to the user device, wherein the output comprises the visual content.

5. The method of claim 1, wherein at least one stage of at least one software test script associated with the first dataset comprises associated text content.

6. The method of claim 5, wherein the training the model comprises inputting the associated text content into the model.

7. The method of claim 6, further comprising:
deploying the trained model;
receiving at least one user query from a user device, wherein the at least one user query comprising at least one word in the text content; and
causing output based on a first statistical inference made by the trained model to be returned to the user device, wherein the output is based on the at least one user query, and wherein a second statistical inference made by the model prior to the training is different from the first statistical inference.

8. The method of claim 1, wherein at least one of the software test scripts comprises an automation test.

9. The method of claim 1, further comprising capturing visual content associated with a first stage associated with a first software test script associated with a first entry in the first dataset.

10. The method of claim 9, wherein the visual content comprises a captured screenshot, and wherein the screenshot depicts a screen illustrative of the first stage.

11. The method of claim 10, further comprising deploying the trained model.

12. The method of claim 11, further comprising, in response to receiving a user query associated with the first stage, providing a response using the trained model, wherein the response comprises the visual content.

13. The method of claim 1, wherein the training the model comprises finetuning the model.

14. The method of claim 1, wherein the plurality of software test scripts comprises human-readable test documentation.

15. The method of claim 1, wherein the plurality of software test scripts comprises computer executable scripts.

16. A method comprising:
determining a plurality of software test scripts;
causing at least a portion of the plurality of software test scripts to be executed on one or more software applications and causing actual outcomes;
determining whether each actual outcome isa positive outcome or a negative outcome based on if each actual outcome matches an associated expected outcome;
determining a first dataset comprising the software test scripts that resulted in a positive outcome and excluding the software test scripts that resulted in a negative outcome; and
training, based on the first dataset, a model.

17. The method of claim 16, wherein at least one software test script associated with the first dataset comprises associated text content.

18. The method of claim 17, wherein the training the model comprises inputting the associated text content into the model, and wherein a statistical inference made by the model prior to the training based on at least one user query about the one or more software applications is different from a statistical inference made by the model after the training based on the at least one user query.

19. The method of claim 18, further comprising:
deploying the model;
receiving the at least one user query from a user device, wherein the at least one user query comprising at least one word in the text content; and
causing output based on the statistical inference made by the model after the training to be returned to the user device.

20. A method comprising:
determining a model configured to respond to user queries;
determining a plurality of software test scripts;
causing at least a portion of the plurality of software test scripts to be executed on a software application and causing actual outcomes;
determining whether each actual outcome is a positive outcome or a negative outcome based on if each actual outcome matches an associated expected outcome;
determining a first dataset comprising the software test scripts that resulted in a positive outcome and excluding the software test scripts that resulted in a negative outcome;
for each entry in the first dataset, capturing image content, wherein at least one image in the captured image content is a screenshot; and
training, based on the first dataset, the model.
